(19) United States
(12) Patent Application Publication
(10) Pub. No.: US 2022/0388851 A1
(43) Pub. Date: Dec. 8, 2022

(54) SYNTHETIC QUARTZ MANUFACTURING METHOD

(71) Applicant: BCnC Co., Ltd., Icheon-si (KR)

(72) Inventor: Don Han KIM, Yongin-si (KR)

(21) Appl. No.: 17/829,897

(22) Filed: Jun. 1, 2022

(30) Foreign Application Priority Data
Jun. 2, 2021 (KR) 10-2021-0071263

(51) Int. Cl. C01B 33/18; B28B 11/24; B28B 1/32

(52) U.S. Cl. CPC C01B 33/183; B28B 11/243; B28B 1/32

(57) ABSTRACT

A method of manufacturing synthetic quartz used for supporting and placing a wafer with a focus ring or edge ring ceramic member which is used during a semiconductor manufacturing process, and the present invention is directed to providing a method of manufacturing cylindrical synthetic quartz which is capable of improving a yield by minimizing temporal loss and quantitative loss and significantly increasing the rate of synthetic quartz production.

### CROSS-REFERENCE TO RELATED APPLICATION

This application claims priority to and the benefit of Korean Patent Application No. 10-2021-0071263, filed on Jun. 2, 2021, the disclosure of which is incorporated herein by reference in its entirety.

### BACKGROUND

### 1. Field of the Invention

The present invention relates to a method of manufacturing synthetic quartz, and more particularly, to a method of manufacturing synthetic quartz used for supporting and placing a wafer with a focus ring or edge ring ceramic member which is used during a semiconductor manufacturing process.

### 2. Discussion of Related Art

Synthetic quartz manufacturing technology is largely divided into two types. First, in a method of manufacturing an optical fiber for communication, the optical fiber consists of an inner core and a clad for the skin, and germanium (Ge) is used as a dopant in the core in order to add a refractive index. A manufactured ingot is made of a thin optical fiber by performing a drawing process in order to make an optical fiber. Before the drawing process is performed, the ingot is made of a material having a height of approximately 1 to 2 meters and a diameter in a range of 100 mm to 150 mm.

Second, in a method of manufacturing an optical lens, unlike the method of manufacturing the optical fiber, an optical lens is made of pure silicon dioxide (SiCl₂) without any distinction between a core and a clad, and an ingot is manufactured to have a different shape for each manufacturer. In the case of Nikon Corp., an ingot with a diameter of 600 mm and a height of about 1,000 mm is manufactured, and in the case of Corning Inc., an ingot with a diameter of 300 mm and a height of about 1,500 mm is manufactured and is used as a material for making a lens.

In a process of manufacturing synthetic quartz, particles (soot) is formed using silicon dioxide precursors and an oxyhydrogen flame, and octamethylcyclotetrasiloxane (OMCTS, C₈H₂₄O₄Si₄), methane (CH₄), or silicon tetrachloride (SiCl₄) gas is used as the precursors.

A complete synthetic quartz ingot is manufactured by performing heat treatment after the particles (soot) is formed, and recently, in foreign companies, cylindrical synthetic quartz is manufactured by dissolving soot powder that has been separated in a deposition process using a natural method.

All of the related art described above have problems. In the method of manufacturing the optical fiber, there is a problem in that it is difficult to make the optical fiber with a large diameter, that is, a diameter, of up to 400 mm, in the method of manufacturing the optical lens, there is a problem in that the method is suitable for manufacturing disks or flat materials and in order to manufacture the material in the form of a ring or cylindrical shape, a core drilling operation for drilling a center is separately needed, and there is a problem in that almost all semiconductor manufacturing equipment for manufacturing a 8″ or 6″ wafer disappears in terms of productivity, and thus internal materials after coring are treated as unusable waste.

In Korean Laid-open Patent Application No. 10-2018-0095880 (Published on Aug. 28, 2018), a technique in which cylindrical synthetic quartz is manufactured by recovering soot powder that is not attached in the synthesis process and heating, that is, melting, the soot powder two or more times to improve internal pores is disclosed. However, the above causes problems with materials because impurities are adsorbed and attached to the soot due to an increase in process through exposure to an atmosphere and melting two or more times.

### DOCUMENT OF RELATED ART

### Patent Document

Korean Laid-open Patent Application No. 10-2018-0095880 (Published on Aug. 28, 2018)

### SUMMARY OF THE INVENTION

The present invention is directed to solving the problems of the related art, and providing a method of manufacturing cylindrical synthetic quartz which is capable of improving a yield by minimizing temporal loss and quantitative loss and significantly increasing the rate of quartz production.

According to an aspect of the present invention, there is provided a technique for manufacturing a complete synthetic quartz ingot by forming a base material in a cylinder type and performing heat treatment on the base material.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic diagram illustrating a method of manufacturing synthetic quartz according to the present invention;

FIG. 2 is an experimental photograph for identifying the presence of pores inside synthetic quartz and natural quartz materials;

FIG. 3 shows photographs showing synthetic quartz and a micro pore explosion phenomenon of natural quartz which occurs under a plasma condition;

FIG. 4 shows a process of manufacturing a synthetic quartz member according to the present invention;

FIG. 5 shows machining operations performed after a method of manufacturing synthetic quartz according to the present invention is performed;

FIG. 6 is a schematic diagram briefly illustrating a facility for a method of manufacturing synthetic quartz according to the present invention;

FIG. 7 is a flowchart illustrating a method of manufacturing synthetic quartz according to the present invention;

FIGS. 8A-8D show deposition operations according to the present invention; and

FIGS. 9 and 10 are diagrams illustrating sintering operations according to the present invention.

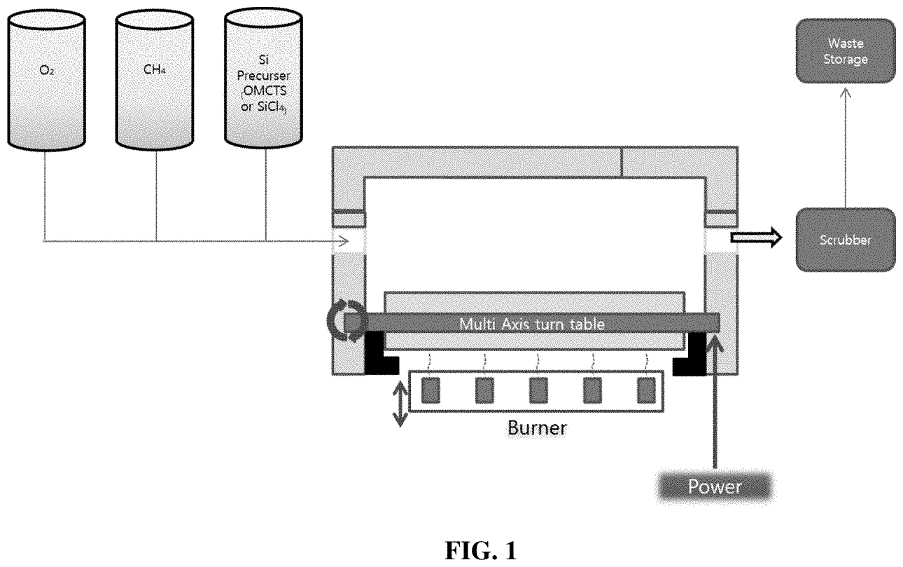

### DETAILED DESCRIPTION OF EXEMPLARY EMBODIMENTS

Hereinafter, embodiments of the present invention that are easily performed by those skilled in the art will be described in detail with reference to the accompanying drawings. However, the present invention may be implemented in several different forms and are not limited to embodiments described below or illustrated in the accompanying drawings. In addition, parts irrelevant to the present invention are omitted in the drawings in order to clearly explain the present invention. The same or similar symbols in the drawings indicate the same or similar components.

Objects and effects of the present invention may be naturally understood or may become more apparent from the following description and the objects and effects of the present invention are not limited only by the following description. Hereinafter, the embodiments according to the present invention will be described in detail with reference to the accompanying drawings.

Briefly described first, the present invention relates to a method of manufacturing synthetic quartz used for supporting and placing a wafer with a focus ring or edge ring ceramic member which is used during a semiconductor manufacturing process. Hereinafter, the present invention will be described in detail with reference to each drawing.

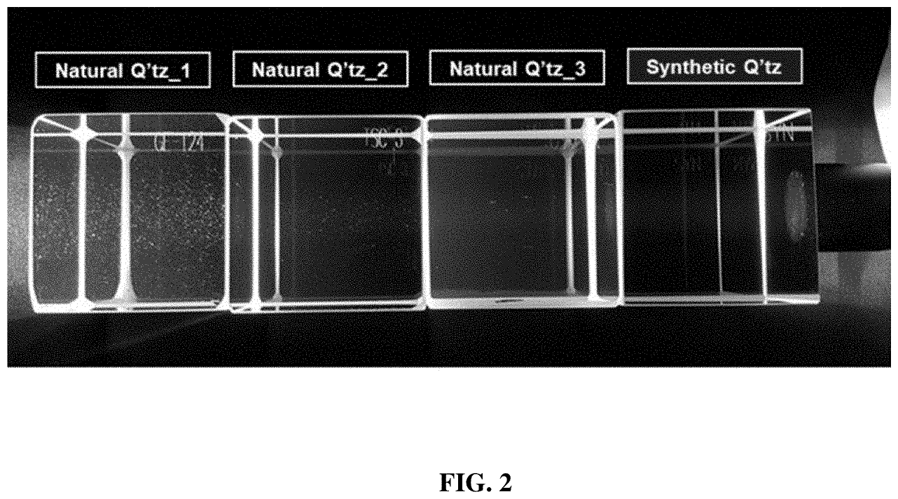

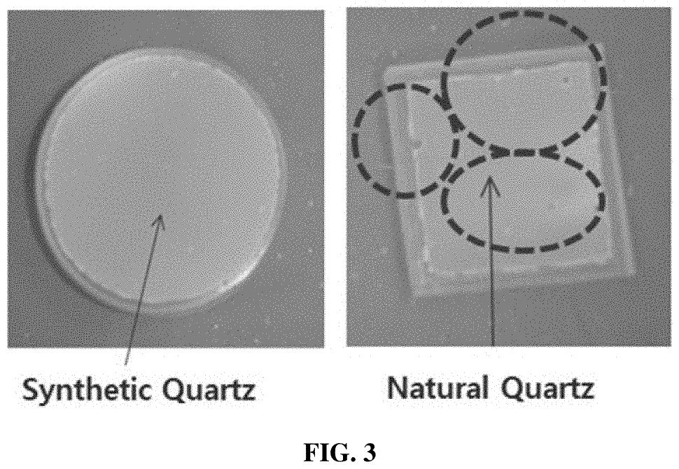

The problems of the related art and the objects of the present invention will be summarized and described in more detail with reference to FIGS. 2 and 3. FIG. 2 is an experimental photograph for identifying the presence of pores inside synthetic quartz and natural quartz materials by transmitting light, and FIG. 3 shows photographs showing synthetic quartz and a micro pore explosion phenomenon of natural quartz which occurs under a plasma condition.

A quartz member used in a process of manufacturing a semiconductor wafer includes natural quartz which is produced by melting solid silicon dioxide inside a mold using flame and electricity. Since it is difficult to purify solid silicon dioxide and high-purity silicon dioxide cannot be made, impurities exist inside the quartz, and there are many micro pores as well as the impurities inside the material. When a surface of the quartz is etched under a plasma in a vacuum atmosphere inside a chamber for semiconductor manufacturing process, a micro explosion occurs in these pores at the time when an interface of the pores is opened, and thus the atmosphere is disturbed to generate SiO₂ and SiO-type micro-particles that are placed on the wafer, thereby affecting chip productivity.

FIG. 3 is photographs obtained by testing natural quartz and synthetic quartz for 90 minutes under plasma conditions of a radio frequency (RF) power of 3,000 W, a vacuum of 10 mTorr or less, and NF₃ and Ar gases. It can be seen that there are traces of micro-explosion in natural quartz, whereas there is no trace of micro-explosion in synthetic quartz.

In order to solve the above problem, high-purity synthetic quartz with no micro pores and few impurities is used as an equipment member for semiconductor manufacturing, and thus the usage of the high-purity synthetic quartz is rapidly increasing.

The reason why the synthetic quartz is of high purity is that a liquid or gas is used as a starting material and the liquid or gas is easier to purify than solid so that the liquid or gas is easy to achieve high purity, the liquid is changed to a gas through a vaporizer and all these gases are purified once more through a purifier, a valve that supplies each gas under optimal conditions for forming an ingot is provided, and the valve is manually adjustable or is adjustable using a computer.

Most types of the synthetic quartz to be used are imported products, and the manufacturing shape thereof has a disc or rod form of which an interior is filled. Therefore, in order to use the synthetic quartz serving as a member for semiconductor manufacturing, an inside area of the synthetic quartz should be dug out and then the synthetic quartz should be made into a ring type. Accordingly, in the present invention, from the beginning, synthetic quartz of a ring-type material is deposited and heat treatment is performed thereon, and thus unnecessary processing processes are omitted.

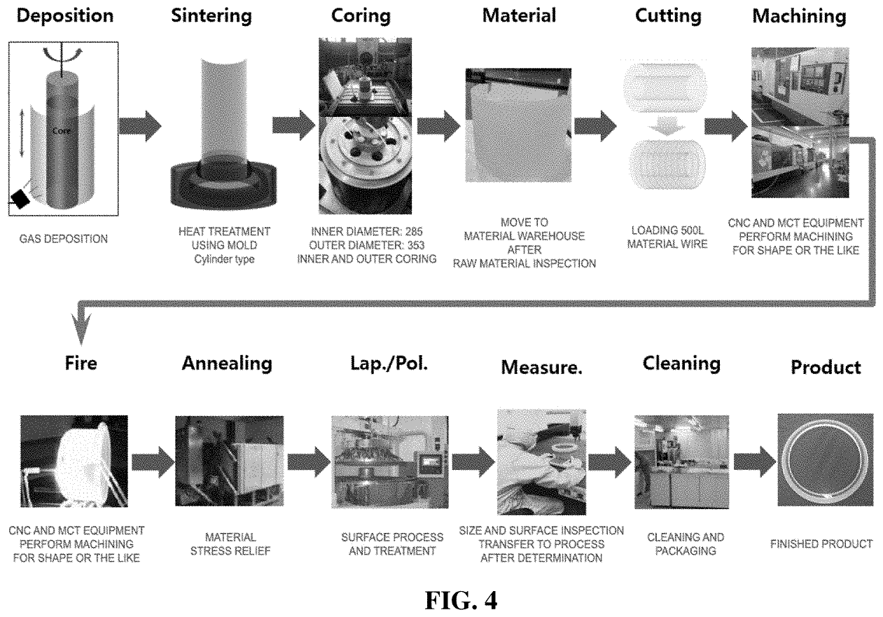

FIG. 4 shows a process of manufacturing a quartz member, including the present invention.

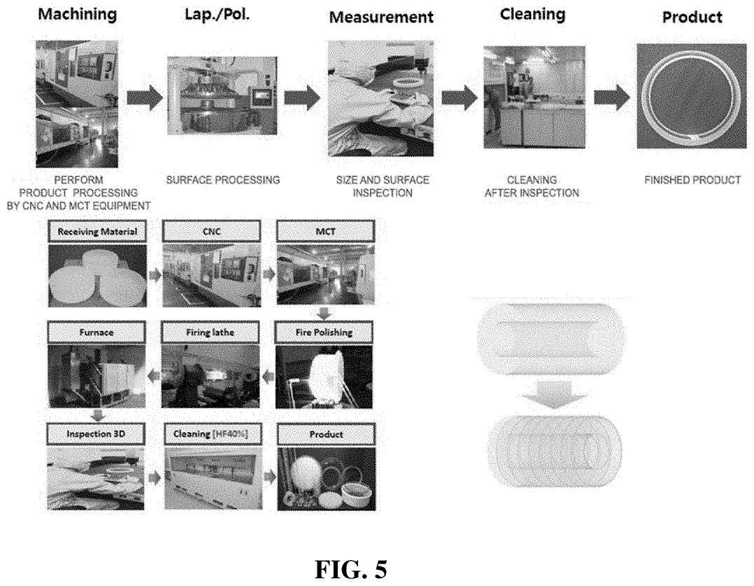

The process of manufacturing the quartz member includes a synthetic quartz manufacturing operation, a machining operation, and a cleaning operation, and in the present invention, a method of manufacturing synthetic quartz including a deposition operation, a sintering operation, and a demolding operation will be described. FIG. 5 shows machining operations performed after the method of manufacturing the synthetic quartz according to the present invention in more detail. The synthetic quartz is processed using computer numerical control (CNC) equipment and/or machining center tool (MCT) equipment, size and surface conditions of the synthetic quartz are inspected after surface processing is performed, and a finished product of the quartz member is manufactured after cleaning and packaging procedures are performed.

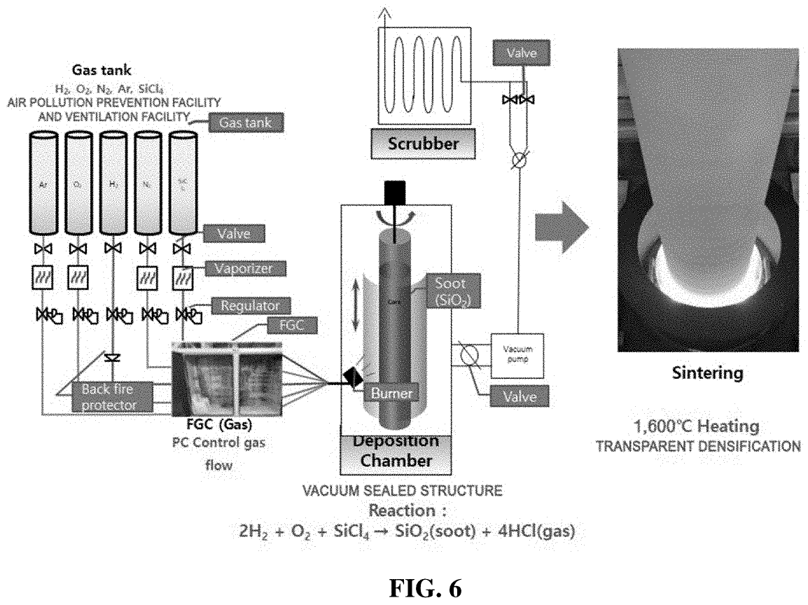

FIG. 6 is a schematic diagram briefly illustrating a facility for a method of manufacturing synthetic quartz according to the present invention. The synthetic quartz manufacturing facility may include a deposition chamber, a vacuum pump, a fuel gas compressor (FGC), and a gas tank.

The deposition chamber is a component for maintaining a vacuum environment in order to deposit fine silicon oxide particles (soot) through deposition and form a base material. Preferably, as the deposition chamber, a deposition chamber capable of maintaining conditions of a vacuum of 10 mTorr or less and NF₃ and Ar plasma is required. The vacuum pump is an exhaust pump for making a vacuum environment of the deposition chamber. Preferably, as the vacuum pump, a dry vacuum pump may be used.

A burner is provided inside the deposition chamber, and source gases (H₂, O₂, N₂, Ar, and SiCl₄) inside the gas tank are compressed through the FGC and then spurted through the burner.

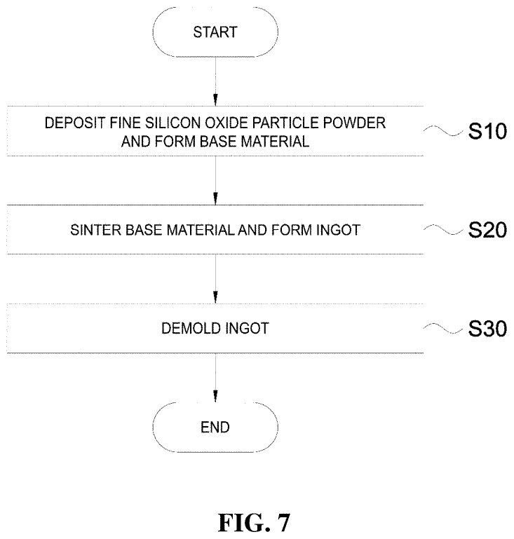

Hereinafter, in order to solve the above-described problems, the present invention will be described in detail with reference to FIGS. 7 to 10.

FIG. 7 is a flowchart illustrating a method of manufacturing synthetic quartz according to the present invention.

The method of manufacturing the synthetic quartz according to the present invention includes a deposition operation S10 of forming a base material, a sintering operation S20 of sintering the base material to form an ingot, and a demolding operation S30 of separating the ingot from a mold.

The deposition operation S10 is an operation of depositing fine silicon oxide particles (soot) on an outer circumferential surface of a deposition member to form a base material. Specifically, the deposition member is provided to have a rod shape and the base material is deposited on the outer circumferential surface of the deposition member. The deposition member may be provided to have a cylindrical shape, a circular tube shape, a truncated conical shape, or a crucible shape, of which a cross section is circular, and may be provided to have one end open. Further, an outer diameter of the deposition member has a size suitable for a 12″ semiconductor wafer and may be set to Ψ280 to Ψ290 in order to reduce the processing process.

As an exemplary embodiment, the deposition member may be made of a material selected from a ceramic material group consisting of graphite, alumina, and silicon carbide or a metal material group consisting of stainless steel, tungsten, and molybdenum, which can withstand a temperature of about 1,600° C. or higher. Accordingly, the deposition member has durability against a combustion reaction of a silicon compound and a sintering temperature to be described below.

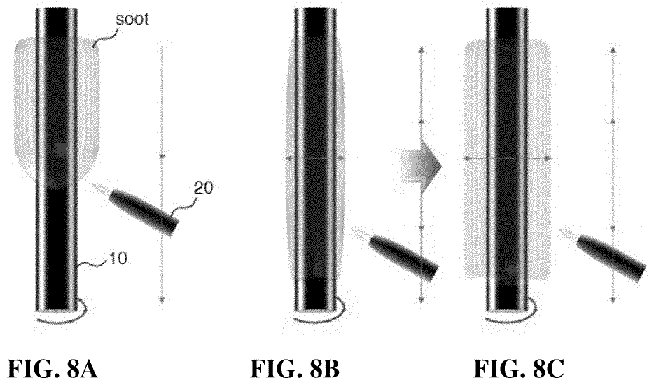

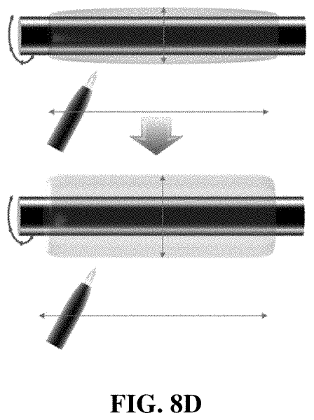

FIGS. 8A-8D show a deposition operation according to the present invention.

A deposition member 10 is positioned and fixed inside the deposition chamber. The fixed deposition member 10 may be rotated, and a rotation speed of the deposition member 10 may be adjusted. The deposition member 10 may have an outer surface roughened or formed with a predetermined pattern or groove so that fine particles (soot) are easily attached. The deposition member 10 may be rotated in various directions such as horizontal and vertical directions, and accordingly, a burner is disposed and moved to correspond to the deposition member 10. Specifically, for example, when the deposition member 10 is provided to have a cylindrical shape, the cylindrical deposition member 10 may be positioned so that its central axis is perpendicular or parallel to the ground, and the cylindrical deposition member 10 may be rotated about the central axis. Further, one to five burner or more burners may be formed according to the size of the deposition member 10, and the burners may be arranged in parallel in a longitudinal direction of the central axis of the deposition member 10. That is, the burners may be arranged vertically or horizontally.

According to an embodiment, description will be made assuming that the deposition member is a cylindrical deposition member. A burner 20 may be positioned to inject gas toward an outer surface of the deposition member, and the burner 20 may be moved up and down.

A silicon compound, which is any one of OMCTS (C₈H₂₄O₄Si₄) and silicon tetrachloride (SiCl₄), is burned in an oxyhydrogen flame through the burner 20. In the present invention, description will be made assuming that the silicon compound is silicon tetrachloride.

The silicon tetrachloride is combusted to form silicon oxide, preferably, fine silicon dioxide (SiO₂) particles (soot), according to the following chemical formula, and the fine particles are deposited on the outer surface of the deposition member.

2H₂+O₂+SiCl₄→SiO₂+4HCl [Chemical formula]

While the deposition member is rotated, the burner is ignited and a gas flow rate is adjusted to proceed with deposition. In this case, the deposition member or the burner may be moved up and down at a constant speed. FIGS. 8B and 8C are schematic diagrams illustrating that the burner is moved back as fine particles (soot) are deposited and the burner is moved up and down. When the burner or the deposition member is not moved, only one place is deposited, and thus either the burner or the deposition member should be moved up and down in order to make a long cylindrical shape.

The gas is continuously discharged through the burner to form the base material, and when an outer diameter of the base material is increased, the burner is moved back by as much as an increased thickness, and thus a constant distance is maintained between an outer surface of the base material and an end of the burner. Preferably, the deposition operation is performed in consideration of the shrinkage of about 50% of the base material after the heat treatment is performed.

The sintering operation is an operation of sintering the base material by performing heat treatment to form an ingot.

The base material on which the fine particles (soot) are deposited shows white and complete densification is not achieved, and thus the base material needs to undergo a separate sintering process. A complete synthetic quartz ingot is manufactured only by performing the sintering process.

In the sintering process, heat treatment may be performed by moving the burner back from the deposition chamber, sealing the deposition chamber, and then raising the temperature of the deposition chamber, or the heat treatment may be performed using separate heat treatment equipment. When the heat treatment is performed in a separate heat treatment furnace, the base material is moved to the heat treatment furnace and then a deposition operation for next production can be performed immediately in the deposition chamber, and thus productivity can be improved.

The heat treatment is performed at a temperature of about 1,500° C. to 1,700° C. Preferably, the heat treatment is performed at a temperature of about 1,600° C., and the base material is sintered into an ingot and undergoes large shrinkage. In this case, in order to prevent pores from being formed inside the material, a certain amount of helium (He) gas is injected to suppress the formation of pores in the base material. Typically, a ring member for 12″ semiconductor equipment has an inner diameter of 296 mm and an outer diameter of 360 mm.

In the sintering process, induction heating and resistance heating may both be used. The induction heating is heat treatment which is performed while an induction coil is moved up and down like a single crystalline silicon refining process, and a separate annealing process should be performed after the induction heating is performed. After the base material is deposited, in the case in which the outer diameter of the base material is large, when the base material is placed in the prepared funnel-type mold (not illustrated, the upper diameter is greater than the lower diameter) and then the outer diameter is reduced by the heat treatment, the base material enters the mold and the shape thereof is completed. After the base material is deposited, in the case in which the outer diameter of the base material is small, the base material is placed in a vertical mold and heat-treated. In this case, a core is heat-treated together with the base material and thus the member is manufactured in a cylindrical shape.

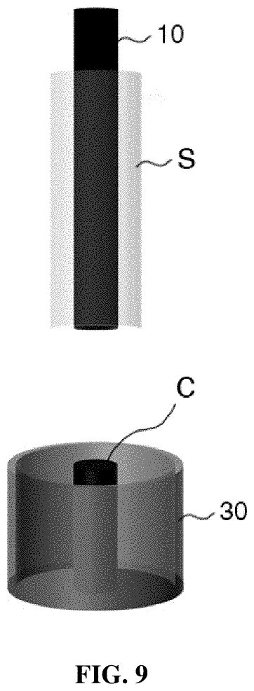

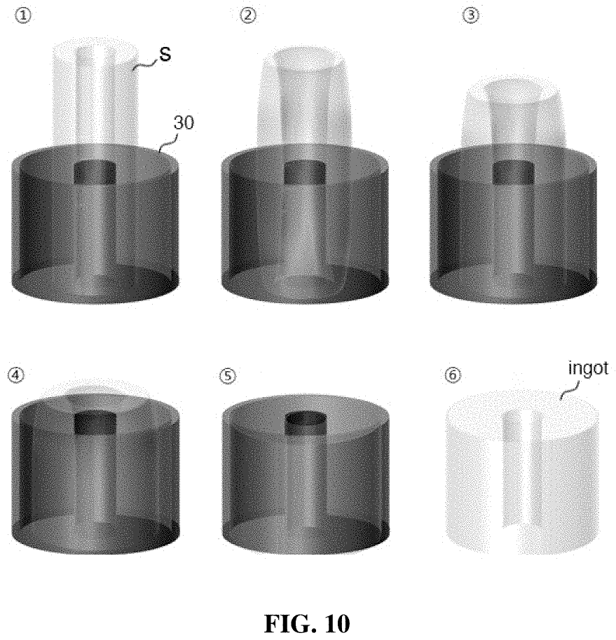

FIGS. 9 and 10 are diagrams illustrating operations of putting a base material having a small outer diameter together with a core into a mold and performing heat treatment on the base material.

Referring to FIG. 9, a base material s is separated from a deposition member 10 and placed in a mold 30 on which a core c is mounted.

\textcircled{1} of FIG. 10 shows a state in which the base material s is placed in the mold 30, and \textcircled{2} to \textcircled{5} of FIG. 10 show states in which the base material s is changed to a cylindrical ingot by performing the heat treatment.

The demolding operation is an operation of separating the sintered ingot from the mold. \textcircled{6} of FIG. 10 shows the ingot after demolding is performed.

Here, the mold may be made of a carbon material, and the mold may be formed to have a predetermined first inner diameter, and thus material loss in subsequent processes can be minimized.

When the base material s is placed in the mold, the base material s may be positioned integrally with the deposition member 10. Specifically, after the deposition is completed, the heat treatment may be performed on the base material s together with the deposition member without change, and in this case, the core does not need to be present inside the mold.

Meanwhile, when the core is provided separately, the deposition member is removed from the base material and then the deposition member is placed in the mold. In this case, the core is inserted into an inner side of the base material inside the mold. The core may be provided to be integrated with or detachable from the base material. Specifically, when the base material is placed in the mold, a core having a second inner diameter smaller than the first inner diameter may be further provided at the center of the base material. The core has a columnar shape and is a component that allows an ingot to have a cylindrical (tubular) shape when the base material is heat-treated in the mold to form the ingot.

Further, in order to easily perform the demolding, outer walls of the core and mold may be made as double outer walls or may be inclined. Specifically, the core or mold may have an inner diameter increasing toward an upper direction, in which the ingot is demolded, so that the heat-treated ingot may be easily demolded. That is, the mold or core may have an inverted truncated conical shape. Further, in order to easily perform the demolding, a release material may be applied to an inner circumferential surface of the mold or a release sheet may be put into the mold. In this case, the release sheet may be a carbon sheet made of a carbon material. Further, in order to easily perform the demolding or prevent the deformation of the mold or ingot in the heat treatment and in the process after the heat treatment, the outer wall of the mold may have a truncated shape. That is, the outer wall of the mold may be provided to be cut diagonally and divided into parts, and the parts may be spaced a predetermined interval from each other.

The superiority of synthetic quartz has been verified, and when the synthetic quartz is manufactured in a cylindrical shape, a positive result can be expected in improving a yield by minimizing loss and significantly increasing the rate of quartz production.

The embodiments of the present invention described above are only examples, and those skilled in the art may make various modifications and equivalent other embodiments therefrom. Therefore, the scope of the present invention is not limited by the above embodiments and the accompanying drawings.

What is claimed is:

1. A method of manufacturing synthetic quartz, the method comprising:
a deposition operation of depositing fine silicon oxide particulate powder along an outer surface of a rod-shaped deposition member at a predetermined thickness to form a base material;
a sintering operation of sintering the base material by performing heat treatment to form an ingot; and
a demolding operation of separating the ingot.

2. The method of claim 1, wherein the deposition member is made of one or more ceramic material groups selected from the group consisting of graphite, alumina, and silicon carbide or one or more metal material groups selected from the group consisting of stainless steel, tungsten, and molybdenum.

3. The method of claim 1, wherein the deposition member has a cylindrical shape, a circular tube shape, a truncated conical shape, or a crucible shape.

4. The method of claim 1, wherein, in the deposition operation, a silicon compound precursor is combusted in an oxyhydrogen flame through a burner that spurts a silicon dioxide precursor, oxygen, and hydrogen in the form of gas, so that the fine silicon oxide particulate powder is formed and deposited.

5. The method of claim 4, wherein the burner is moved along an outer circumferential surface of the deposition member, and the base material is uniformly deposited on the outer surface of the deposition member at the predetermined thickness by the rotation of the deposition member.

6. The method of claim 4, wherein the silicon dioxide precursor is octamethylcyclotetrasiloxane (OMCTS) (C₈H₂₄O₄Si₄), methane (CH₄), or silicon tetrachloride (SiCl₄).

7. The method of claim 1, wherein, in the sintering operation, the base material is placed inside a mold having a predetermined first inner diameter and then sintered by performing the heat treatment so that the ingot is formed.

8. The method of claim 7, wherein the mold further includes a cylindrical core having a predetermined second diameter smaller than the predetermined first inner diameter.

9. The method of claim 1, wherein the heat treatment in the sintering operation uses induction heating using an induction coil or resistance heating, and is performed at a temperature of 1,500° C. to 1,700° C.

10. The method of claim 1, wherein, in the sintering operation, He gas is injected to prevent pores from being formed.

11. The method of claim 7, wherein the inner diameter of the mold is increased in a direction in which the ingot is demolded.

12. The method of claim 7, wherein the mold is made of a carbon material and has an outer wall cut diagonally and divided.

13. The method of claim 1, wherein a collecting device that collects fine silicon oxide particulate powder that does not deposited on the deposition member is further provided in the deposition operation.

14. The method of claim 1, wherein the deposition member is formed to be perpendicular or parallel to a ground.

15. The method of claim 7, wherein the heat treatment in the sintering operation uses induction heating using an induction coil or resistance heating, and is performed at a temperature of 1,500° C. to 1,700° C.

16. The method of claim 7, wherein, in the sintering operation, He gas is injected to prevent pores from being formed.
